(19) United States
(12) Patent Application Publication
(10) Pub. No.: US 2017/0339481 A1
(43) Pub. Date: Nov. 23, 2017

(54) EARPIECE SYSTEM

(71) Applicant: Harman International Industries, Inc., Stamford, CT (US)

(72) Inventor: Ely William LABERGE, Ferguson, MO (US)

(73) Assignee: Harman International Industries, Inc., Stamford, CT (US)

(21) Appl. No.: 15/521,041

(22) PCT Filed: Oct. 30, 2015
(86) PCT No.: PCT/US2015/058345

§ 371 Date: Apr. 21, 2017

Related U.S. Application Data
(63) Continuation of application No. 29/531,398, filed on Jun. 25, 2015, now Pat. No. D770426.
(60) Provisional application No. 62/073,942, filed on Oct. 31, 2014.
(60) Provisional application No. 62/213,283, filed on Sep. 2, 2015.

(51) Int. Cl. H04R 1/10

(52) U.S. Cl. CPC H04R 1/1016; H04R 2460/11

(57) ABSTRACT

In one embodiment, an earpiece system comprising an enhancer is provided. The enhancer is configured to receive an earbud of a speaker and to fit in a user's ear. The enhancer includes a first portion having a first surface that defines a concave crus relief feature. The enhancer further includes a second portion extending from the first portion and forming a sound tunnel having an opening at an end opposite the first portion, and a flexible skirt positioned with the sound tunnel and projecting over the second portion to resiliently seal with the user's ear canal when inserted therein.

### CROSS-REFERENCE TO RELATED APPLICATIONS

This application claims the benefit of U.S. provisional application Ser. No. 62/073,942, filed Oct. 31, 2014 and U.S. provisional application Ser. No. 62/213,283 filed on Sep. 2, 2015, and claims priority to U.S. application Ser. No. 29/531,398, filed Jun. 25, 2015, the disclosures of which are hereby incorporated by reference in their entirety.

### TECHNICAL FIELD

Aspects disclosed herein generally relate to an earpiece system. Specifically, aspects disclosed herein generally related to earpiece systems, such as earphones and earbuds, and in particular to an improved enhancer for use in earbuds and earphones.

### BACKGROUND

U.S. Publication No. 2015/0030194 to Burgett et al. provides, among other things, an earbud adapter or in-ear monitor that includes an ear interface that fits the human ear and further permits the wearer of these devices to adjust parameters of the fit. In additional aspects, the ear interface portion of these devices permits the user to adjust the transmission of ambient sound. The ear interface portion also allows the user to change ornamentation.

### SUMMARY

In one embodiment, an earpiece system comprising an enhancer is provided. The enhancer is configured to receive an earbud of a speaker and to fit in a user's ear. The enhancer includes a first portion having a first surface that defines a concave crus relief feature. The enhancer further includes a second portion extending from the first portion and forming a sound tunnel having an opening at an end opposite the first portion and a flexible skirt positioned with the sound tunnel and projecting over the first portion to resiliently seal with the user's ear canal when inserted therein.

In one embodiment, an earpiece system comprising an enhancer is provided. The enhancer is configured to engage a speaker and fit into a user's ear. The enhancer includes a first portion and a traction feature including a plurality of grooves oriented on the first portion. The enhancer further includes a second portion extending from the first portion and forming a sound tunnel having an opening at an end opposite the first portion and a flexible skirt positioned with the sound tunnel and projecting over the first portion to resiliently seal with the user's ear canal when inserted therein.

In one embodiment, an earphone for connection to an audio source is provided. The earphone includes a speaker and an enhancer. The enhancer is configured to engage the speaker and to fit into a user's ear. The enhancer includes a flexible hollow body defining a concave crus relief feature on an outer surface thereof and configured to fit into the user ear. The enhancer further includes a tube extending from the body and having an opening at an end opposite the body and a flexible tapered section positioned with the tube and projecting over the body to resiliently seal with a user's ear canal when inserted therein.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a front elevation view of an enhancer for an ear piece system in accordance to one embodiment;

FIG. 2 is a rear elevation view of the enhancer in accordance to one embodiment;

FIG. 3 is a top plan view of the enhancer in accordance to one embodiment;

FIG. 4 is a bottom plan view of the enhancer in accordance to one embodiment;

FIG. 5 is a front elevation view of the enhancer in accordance to one embodiment;

FIG. 6 is a rear elevation view of the enhancer in accordance to one embodiment;

FIG. 7A is a front perspective view of the ear piece system in accordance to one embodiment;

FIG. 7B is a rear perspective view of the ear piece system in accordance to one embodiment;

FIG. 7C is a front elevation view of one embodiment of the earpiece system in accordance to one embodiment;

FIG. 7D is a rear end view of one embodiment of the earpiece system;

FIG. 7E is a front elevation view of the speaker unit with the enhancer removed in accordance to one embodiment;

FIG. 7F is a side elevation view of the speaker unit with the enhancer removed in accordance to one embodiment;

FIG. 8 is a perspective view of the enhancer with the flexible dome flipped outwardly to an as-manufactured configuration in accordance to one embodiment;

FIG. 9 is a side elevation view of the enhancer of the earpiece system in accordance to one embodiment;

FIG. 10 is a side elevation view of the enhancer of FIG. 9 in accordance to one embodiment;

FIG. 11 is a front view of the enhancer of FIG. 9 in accordance to one embodiment;

FIG. 12 is a rear view of the enhancer of FIG. 9 in accordance to one embodiment;

FIG. 13 is a top view of the enhancer of FIG. 9 in accordance to one embodiment;

FIG. 14 is a bottom view of the enhancer of FIG. 9 in accordance to one embodiment;

FIG. 15 is a side elevation view of the enhancer of FIG. 9 including a flexible tapered section being flipped outwardly in accordance to one embodiment;

FIG. 16 illustrates a three-part tool adapted to make the enhancer and further illustrates an upper surface of an intermediate plate and a lower surface of a top plate;

FIG. 17 illustrates the three-part tool including the upper surface of the intermediate plate, an upper surface of a base plate, and the lower surface of the top plate;

FIG. 18 illustrates the three-part tool including the upper surface of the intermediate plate;

FIG. 19 illustrates the three-part tool including the upper surface of the base plate and the lower surface of the top plate;

FIG. 20 illustrates the three-part tool including the lower surface of the intermediate plate and the upper surface of the base plate; and

FIG. 21 illustrates the three-part tool including the lower surface of the intermediate plate and the upper surface of the base plate.

Corresponding reference numerals indicate corresponding parts throughout the several views of the drawings.

### DETAILED DESCRIPTION

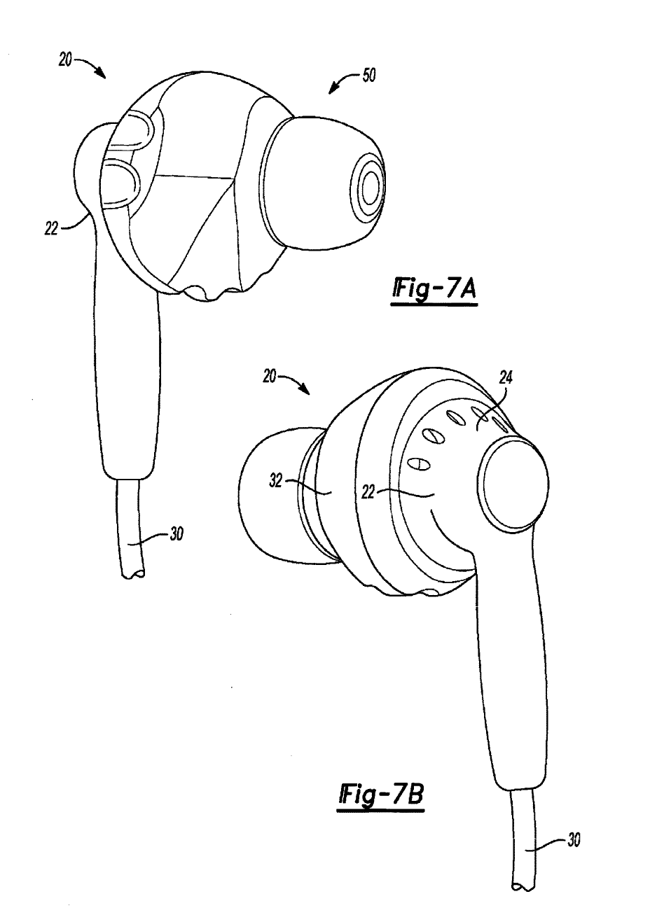

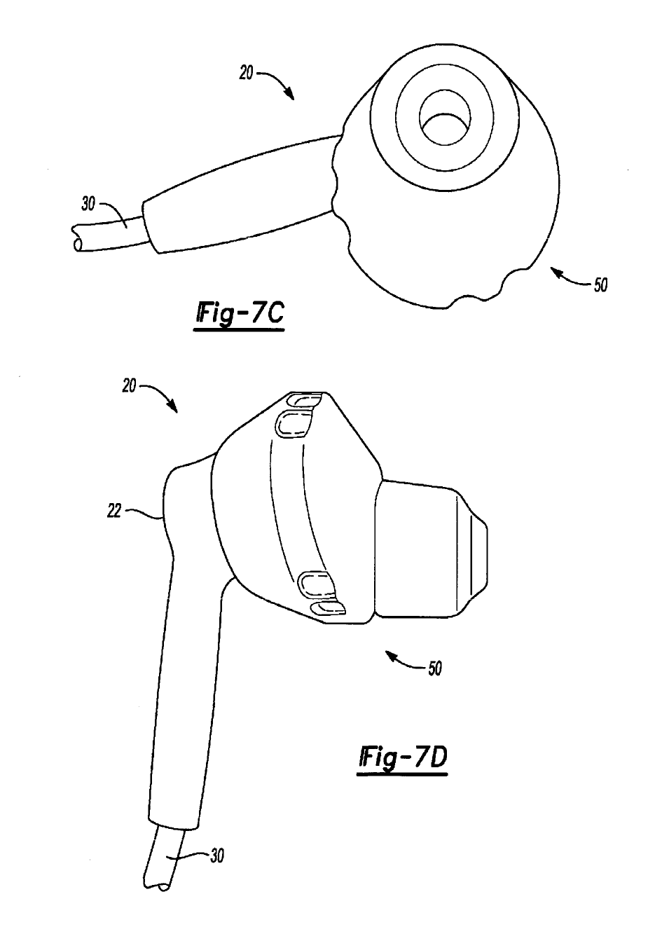

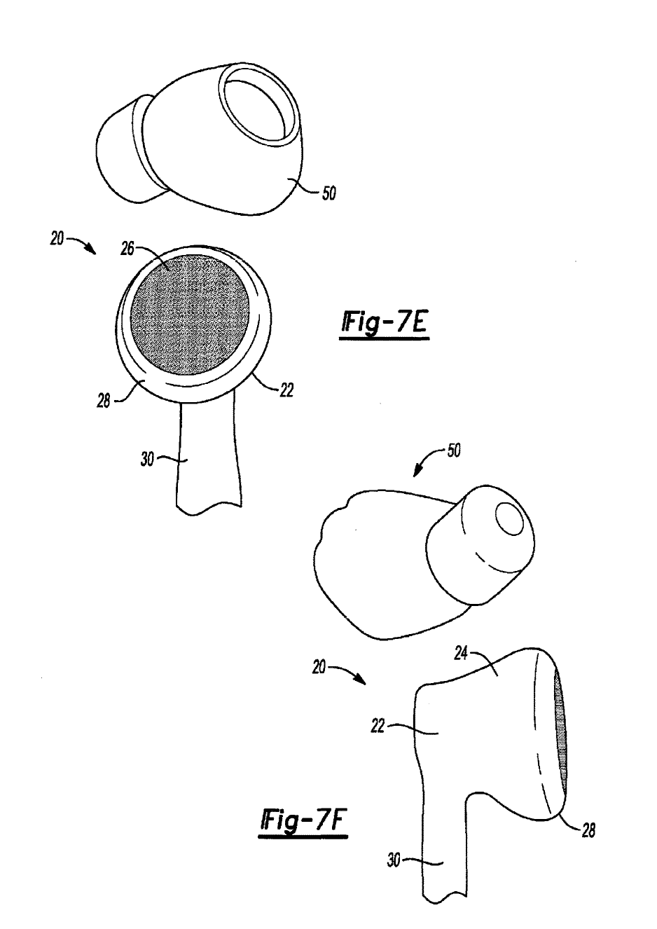

Example embodiments will now be described more fully with reference to the accompanying drawings. In general, embodiments of the present invention provide an earpiece system for use with electronic devices such as computers, cell phones, and mp3 players or other audio devices. One embodiment of an earpiece system or earbud constructed according to the disclosure herein is indicated generally as 20 in FIG. 7A-7F. The earbud 20 comprises a speaker unit 22, comprising a generally frustoconical housing 24 having a generally circular front face 26, surrounded by a peripherally projecting raised rim 28. A wire conduit 30 extends from adjacent a bottom of the housing 24, generally perpendicular to an axis of a flexible dome 88 (or first skirt), and ends in a resilient collar 32. A speaker (not shown) is disposed in the housing 24, facing the front face 26. Speaker wires face the front face 26, and speaker wires 34 extend from the speaker unit 22, through a wire conduit 30.

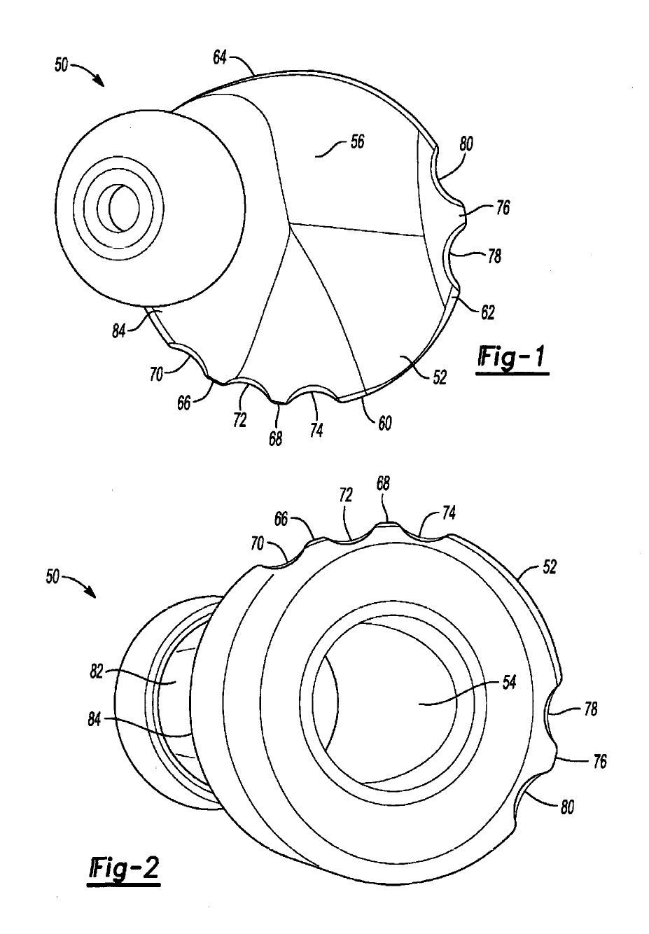

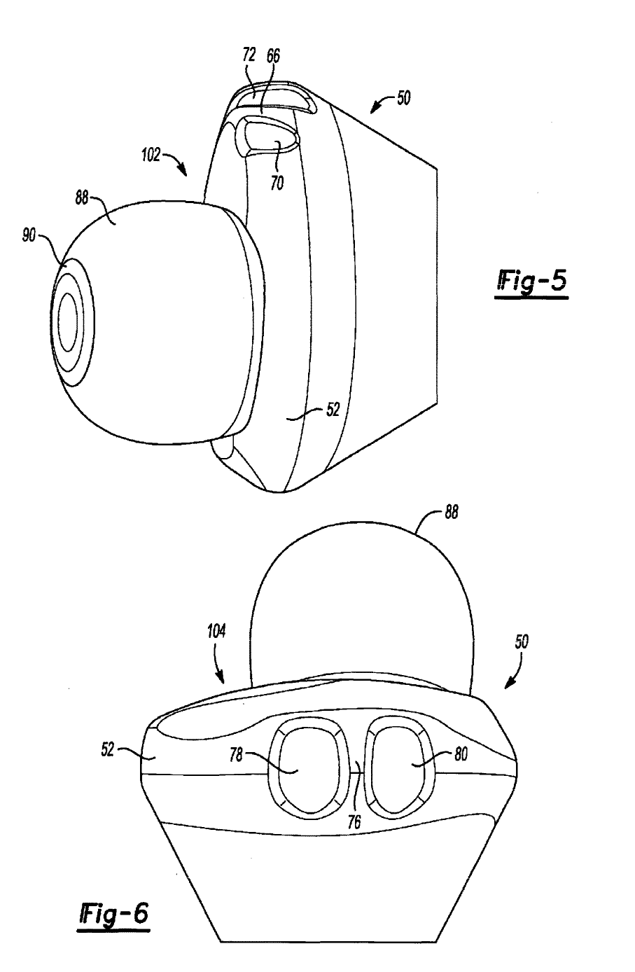

In accordance with the principles of embodiments disclosed herein, an ear interface or enhancer 50 is mounted over the speaker unit 22 (see FIGS. 1-6, 7A-7F and 8). The enhancer 50 comprises a body 52 having a chamber and a rear opening 54 for receiving the front portion of the speaker unit 22. The tapering shape of the frustoconical housing 24 helps retain the enhancer 50 on the speaker unit 22. A body 52 of the enhancer 50 has a generally oval shape, with a generally flat front face 56 that is adapted to fit within and face a concha of the user's ear. The flat front face 56 includes a transversely extending crus relief groove 58 (i.e., a first traction feature) that extends from a bottom edge 60, adjacent a rear edge 62, to a top edge 64. The crus relief groove 58 widens from the bottom edge 60 toward the top edge 64 of the front face 56.

Contact pads 66 and 68 are formed in the bottom edge 60 of the front face 56, by notches 70, 72, and 74. Contact pad 76 is formed in the rear edge 62 of the front face 56, by notches 78 and 80. Each of the contact pads 66, 68, 76 and the notches 70, 72, 74, 78, and 80 may also be part of, or form a second traction feature.

A tube 82 (or sound tunnel) extends from the front face 56, adjacent to the forward end 84. The tube 82 is generally cylindrical, and extends from a flat face 86 on the front face 56 opposite from the crus relief groove 58. The flexible dome 88 projects outwardly from the body 52 and downwardly from the top of the tube 82 to therefore surround the tube 82. The flexible dome 88 surrounds a majority of the tube 82. In this case, the flexible dome 88 may surround more than half of the length of the tube 82. In another example, the flexible dome 88 may surround the entire length of the tube 82. The flexible dome 88 may be integral with, and more specifically formed integrally with, the tube 82. The flexible dome 88 flexes to fit and engage an interior wall (or interior circular wall) of the user's ear canal, forming a seal that restricts extraneous ambient sound entering the ear. This engagement can also help retain the enhancer 50 in the user's ear. This provides a more secure engagement and can lessen the reliance of the body engaging with the external structure of the user's ear. A ring 90 is formed at the top of the dome 88 and surrounds an opening 92 of the tube 82. A sound tunnel axis 103 is generally shown that extends from the rear opening 54 of the body 52 through the tube 82 and the surrounding flexible dome 88.

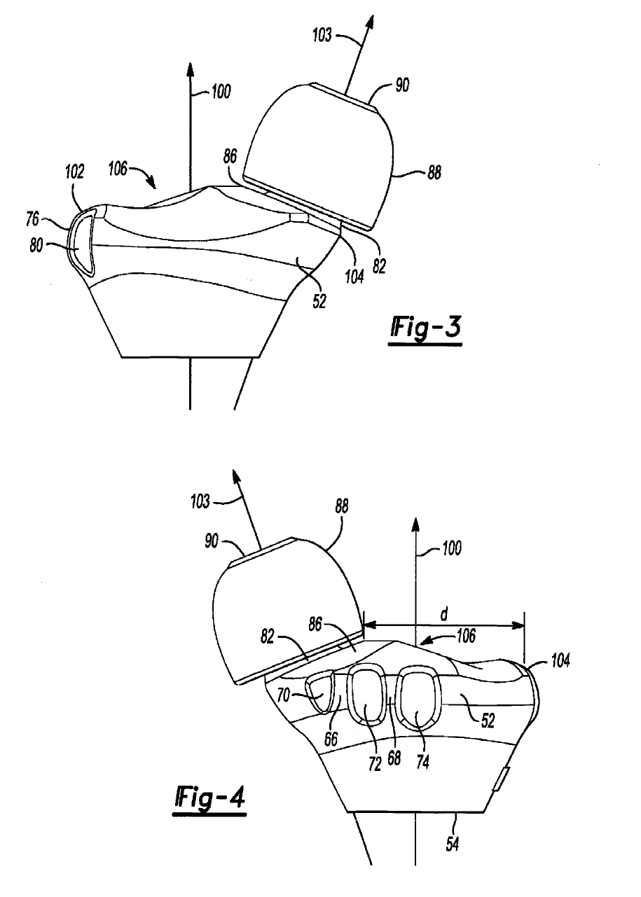

In reference to FIGS. 3-6, a central axis 100 is generally shown that extends from the rear opening 54 of the body 52 and through a center portion 106 of the body 52. As can be seen, the sound tunnel axis 103 intersects with the central axis 100 at some point. In other words, the sound tunnel axis 103 is angularly offset from the central axis 100. A bottom portion 102 of the body 52 is positioned adjacent to the center portion 106. A top portion 104 of the body is positioned adjacent to the center portion 106 and opposite to the bottom portion 102. As can be seen, the flexible dome 88 and the tube 82 are positioned on the bottom portion 102 of the body 52. As can also be seen, the crus relief groove 58 may be positioned on the top portion 104 and the center portion 106 of the body 52. Thus, when the enhancer 50 is inserted into the user's ear, the crus relief groove 58 contacts a crus or valley of the user's ear that is proximate to a top of the user's ear canal. Likewise, when the enhancer 50 is inserted into the user's ear, the flexible dome 88 at the bottom portion 102 enters into the user's ear canal given that the user's ear canal is located underneath the crus of the user's ear. The center portion 106 of the body 52 occupies a distance “d” (see FIG. 4) between the top portion 104 and the bottom portion 102. The distance of the center portion 106 may include at least a portion of the crus relief groove 58 to a point adjacent to flexible dome 88 (but not under the flexible dome 88). The distance of the center portion 106 and position of the flexible dome 88 at the bottom portion 102 may enable the dome 88 to be adequately placed at a position within the user's ear canal to receive audio at an adequate level. Further, this condition may enable a larger percentage of the flexible dome 88 to enter into the user's ear canal thereby improving the retention and the length of time that the flexible tapered section 96 is in the user's ear canal.

FIG. 9 is a side elevation view of the enhancer 50 of the earpiece system in accordance to another embodiment. The enhancer 50 as illustrated in connection with FIG. 9 includes a flexible tapered section 96 (a second skirt) as opposed to the generally flexible dome 88. The flexible tapered section 96 projects over the body 52 (or the second portion) to resiliently seal with the ear canal of the user when inserted therein. The flexible tapered section 96 flexes to fit and engage the interior wall of the user's ear canal thereby forming a seal that restricts extraneous ambient sound from entering into the user's ear. Thus, the flexible tapered section 96 may adequately occlude the user's ear canal to prevent ambient or undesired sound from entering into the user's ear.

It should be appreciated that initial diameter of the flexible tapered section 96 may be smaller than that of the flexible dome 88. In this case, the flexible tapered section 96 may fit better into the interior wall of the user's ear canal. For example, upon insertion of the enhancer 50 into the ear, the diameter of the flexible tapered section 96 will increase and eventually form an interference fit with the interior wall of the user's ear canal. This condition may enable a larger percentage of the flexible tapered section 96 to enter into the user's ear canal thereby improving the retention and the length of time that the flexible tapered section 96 is in the user's ear canal. An overall thickness of the flexible tapered section 96 may be less than the overall thickness of the wall(s) that form the body 52. Thus, the flexible tapered section 96 may provide adequate levels of comfort and easily conform to the interior wall of the user's ear canal during insertion due to the reduced thickness of the flexible tapered section 96. As shown in FIG. 9, all other aspects of the enhancer 50 include features that were previously described.

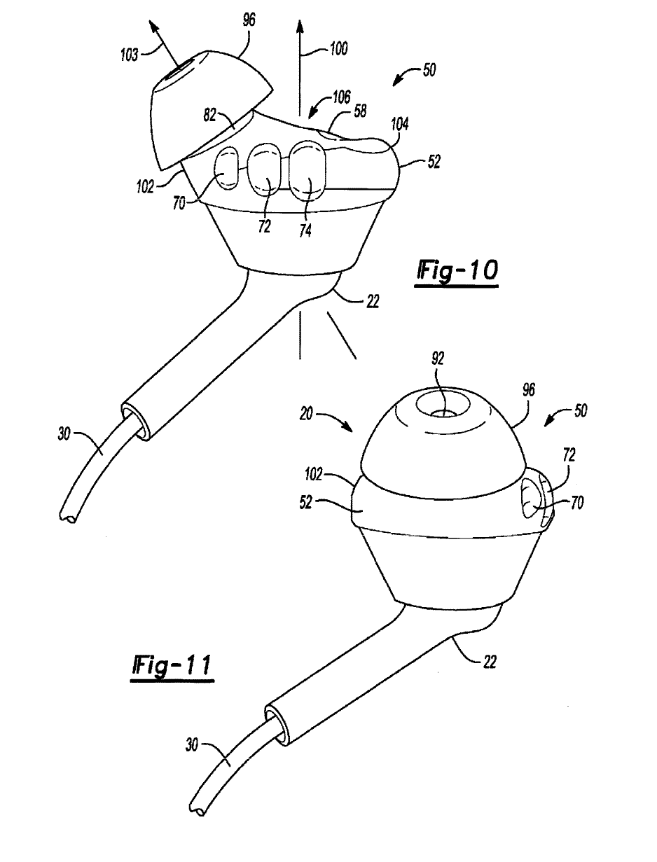

FIG. 10 is a side elevation view of the enhancer 50 including the flexible tapered section 96 of the earpiece system in accordance to one embodiment. The tube 82 extends from the body 52 of the enhancer 50 to support the flexible tapered section 96. The thickness of the wall that forms the tube 82 may be greater than the thickness of the flexible tapered section 96 to adequately support the flexible tapered section 96 during insertion into the user's ear canal. The flexible tapered section 96 generally covers or surrounds the tube 82. The tube 82 and the flexible tapered section 96 may be orientated at an angle of generally 100 degrees in reference to an imaginary line that extends transversely on an x-axis from one end of the body 52 to the other end of the body 52. Due to this orientation, a portion of the flexible tapered section 96 extends over the body 52.

As can be seen in FIG. 10, the tube 82 and the flexible tapered section 96 are positioned on the bottom portion 102 of the body 52. As noted above, the top portion 104 of the body is positioned adjacent to the center portion 106 and opposite to the bottom portion 102. As can also be seen, the crus relief groove 58 may be positioned on the top portion 104 and the center portion 106 of the body 52. Thus, when the enhancer 50 is inserted into the user's ear, the crus relief groove 58 contacts a crus or valley of the user's ear at a proximate to a top of the user's ear canal. Likewise, when the enhancer 50 is inserted into the user's ear, the flexible tapered section 96 at the bottom portion 102 enters into the user's ear canal given that the user's ear canal is located underneath the crus of the user's ear. The center portion 106 of the body 52 occupies a distance “d” (see FIG. 10) between the top portion and the bottom portion. The distance of the center portion 106 may include at least a portion of the crus relief groove 58 to a point adjacent to the flexible tapered section 96 (but not under the flexible tapered section 96). The distance of the center portion 106 and position of the flexible tapered section 96 at the bottom portion 102 may enable the flexible tapered section 96 to be adequately placed at a position within the user's ear canal to receive audio at an adequate level. Further, this condition may enable a larger percentage of the flexible tapered section 96 to enter into the user's ear canal thereby improving the retention and the length of time that the flexible tapered section 96 is in the user's ear canal.

FIG. 11 is a front view of the enhancer 50 including the flexible tapered section 96 of the earpiece system in accordance to one embodiment. As illustrated, the opening 92 extends through the tube 82 and through an outer portion of the flexible tapered section 96 to enable audio signals to be transmitted to the ear canal of the user when the enhancer 50 is inserted in to the user's ear.

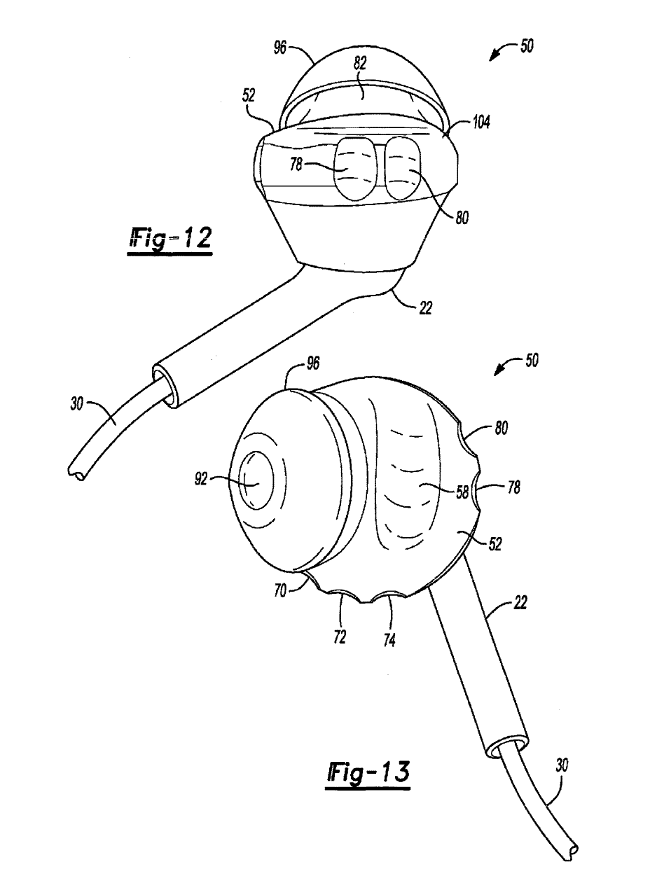

FIG. 12 is a rear view of the enhancer 50 including the flexible tapered section 96 of the earpiece system in accordance to one embodiment. As illustrated, the flexible tapered section 96 surrounds a majority of the tube 82. In this case, the flexible tapered section 96 may surround more than half of the length of the tube 82. In another example, the flexible tapered section 96 may surround the entire length of the tube 82. It is recognized that the tube 82 may flex inward in the event the interior wall of the user's ear canal applies a force against both the flexible tapered section 96 and the tube 82. This condition prevents the user from experiencing discomfort or pain.

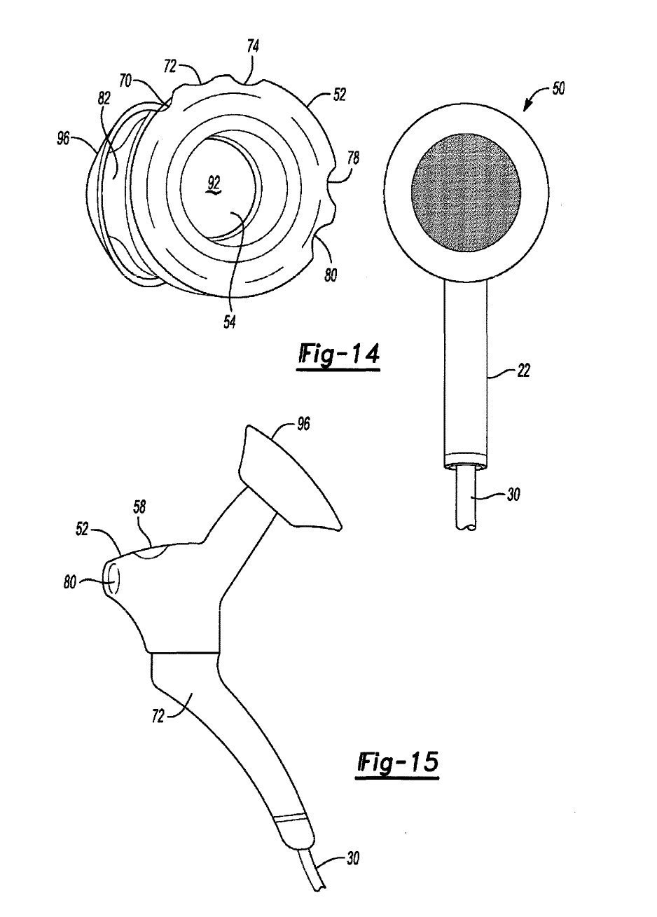

FIG. 13 is a top view of the enhancer 50 including the flexible tapered section 96 of the earpiece system in accordance to one embodiment. FIG. 14 is a bottom view of the enhancer 50 including the flexible tapered section 96 of the earpiece system in accordance to one embodiment. As illustrated, the body 52 defines the rear opening 54 to enable audio signals to pass through the tube 82 and out of the opening 92 positioned on top of the tube 82 and on the top of the flexible tapered section 96. FIG. 15 is a side elevation view of the enhancer 50 including the flexible tapered section 96 being flipped outwardly in accordance to one embodiment.

In general, the enhancer 50 may be made from a resilient polymeric material that is sufficiently flexible such that the rear opening 54 can stretch to accommodate the insertion and removal of the speaker unit. The material is also sufficiently flexible that the dome 88 and the tapered section 96 can deform to accommodate the user's ear canal without applying undue pressure on the tissue. The polymeric material may provide a smooth continuous surface without seams or joints that might irritate the user's ear, and specifically the user's ear canal. The surface may be smooth, but not slick so that the enhancer 50 comfortably remains in place, even during strenuous exercise.

While the earbud is shown in the drawings and described in the specification as having a wired speaker unit 22, i.e., one with a wire conduit 30, the earbud system is not so limited and the speaker unit 22 could be a wireless speaker unit, in which case there may or may not a wire extending from the speaker unit. In a wireless embodiment, there may or may not be an element extending between two speaker units.

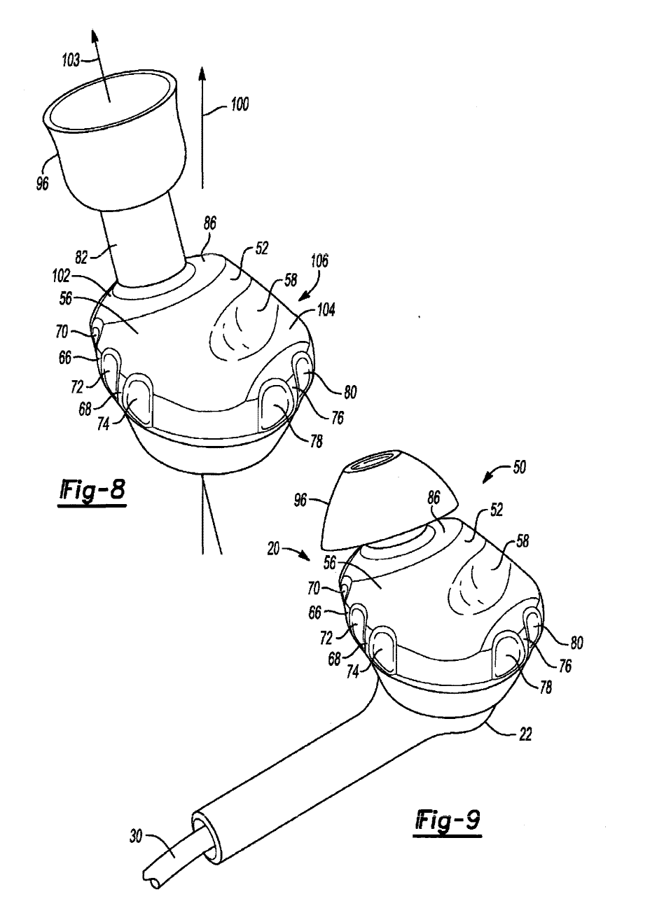

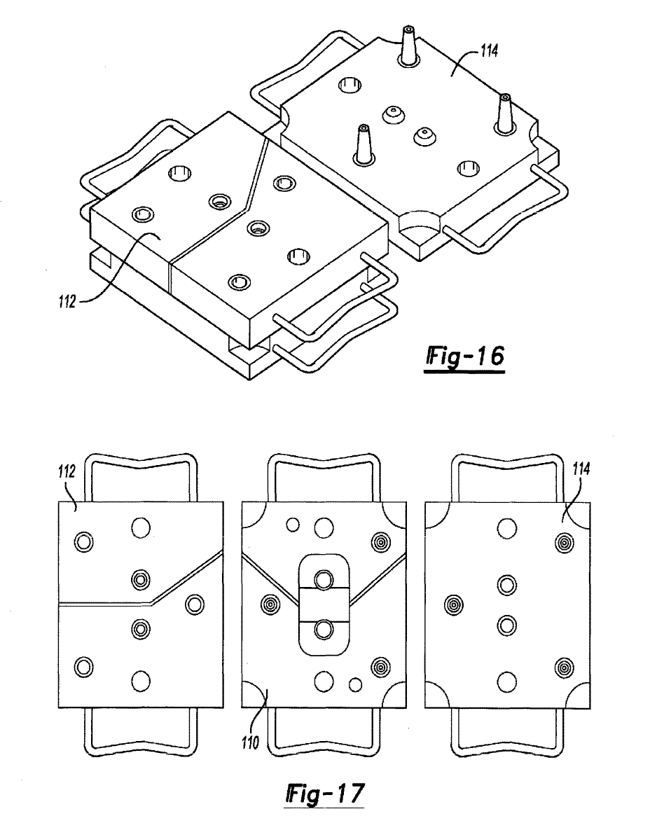

The enhancer 50 can be made in a variety of ways, but in one manner, the enhancer 50 is made using a three-piece mold as shown in FIGS. 16 to 21. Such a mold allows the dome 88 to be molded as a bowl-shaped extension 94 at the end of the tube 82 (see FIG. 8). Such a mold may also allow the section 96 to be molded as a tapered (or skirt) shaped extension at the end of the tube 82 (see FIG. 9). Once the enhancer is removed from the mold, the cup-shaped extension (or tapered section) can be “flipped” down to form the flexible dome 88 that surrounds the tube 82.

Still another embodiment of the present disclosure provides a method of making an ear interface for an ear phone. Generally, the method comprises molding an ear interface body having a first portion with a first surface that defines a concave crus relief feature; and a second portion extending from the first portion and forming a sound tunnel having an opening at an end opposite the first portion, and a bowl-shaped element (or tapered-shaped element) extending from the end of the second portion, and thereafter, inverting the bowl-shaped element over the second portion to form a dome-shaped element (or tapered-shaped element) projecting over the second portion that can resiliently seal with the users ear canal when inserted therein.

The interface can be conveniently molded in a three piece mold, such as the three piece mold shown in FIGS. 16-21. The first portion molded between a base plate 110 and an intermediate plate 112, the second portion molded in the intermediate plate 112, and the bowl-shaped element being molded between the intermediate plate 112 and a top plate 114.

FIG. 16 illustrates a three-part tool adapted to make the enhancer 50, showing an upper surface of the intermediate plate 112 on the left, with cavities for forming exteriors of the bowl-shaped elements, and a lower surface of the top plate 114 on the right, with projections for forming the interiors of the bowl-shaped elements.

FIG. 17 illustrates the three-part tool base plate 110 including an upper surface of the intermediate plate on the left, the upper surface of the base plate 110 in the middle, with cavities for forming the first portion, and the lower surface of the top plate 114 on the right.

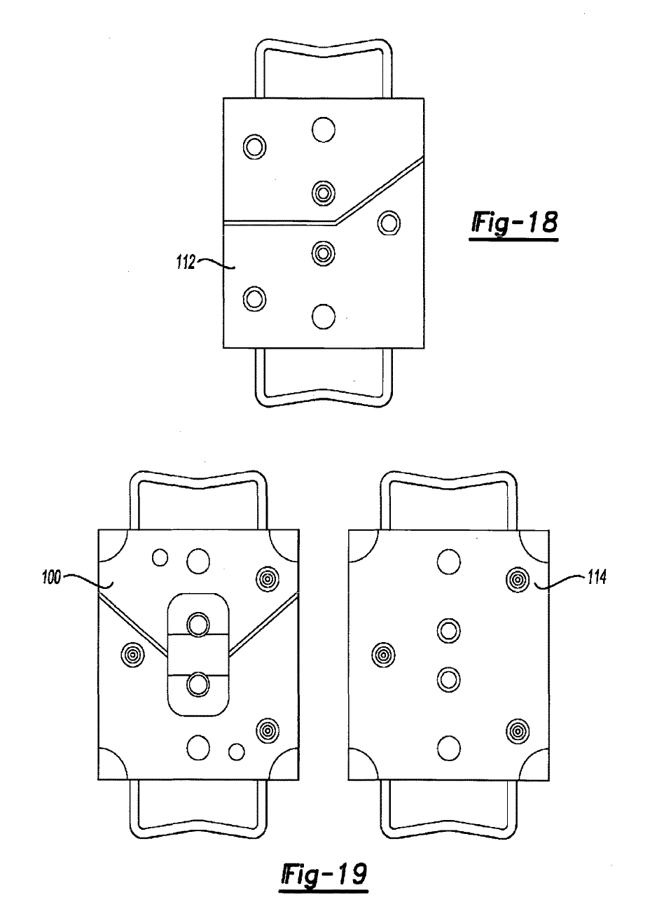

FIG. 18 illustrates the three-part tool including the upper surface of the intermediate plate 112.

FIG. 19 illustrates the three-part tool including the upper surface of the base plate 110, and the lower surface of the top plate 114.

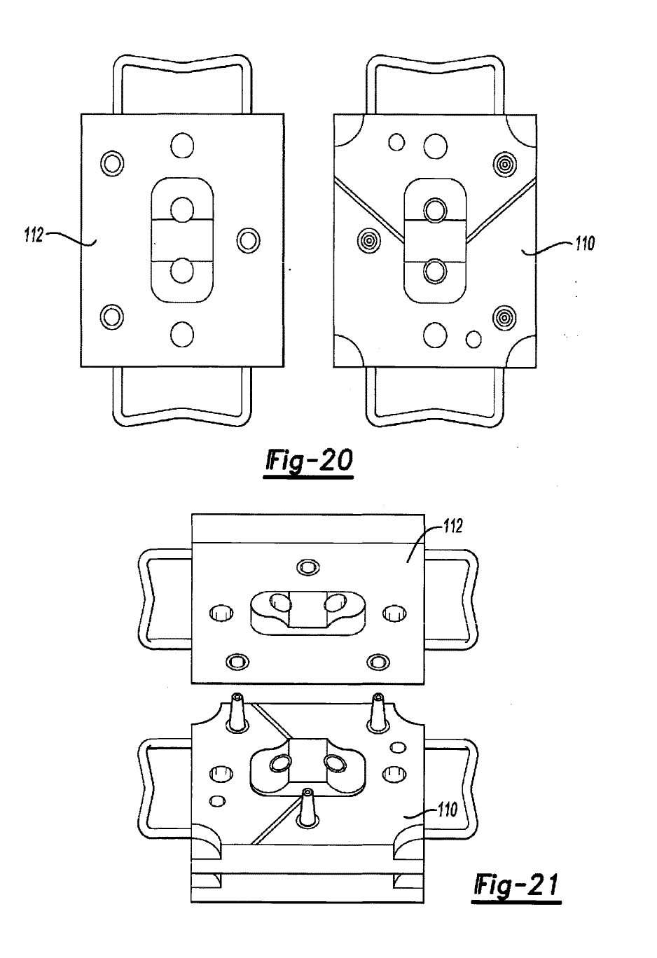

FIG. 20 illustrates the three-part tool including the lower surface of the intermediate plate 112 on the left, with cavities for forming the first portion, and the upper surface of the base plate 110.

FIG. 21 illustrates the three-part tool including the lower surface of the intermediate plate 112 and the upper surface of the base plate 110. An enhancer that is removed from the mold, is shown resting on the surface of the base plate 110. The features disclosed herein provide a number of aspects. As noted above, an earpiece system comprises a speaker and an enhancer. The enhancer comprises a first portion having a first surface that defines a concave crus relief feature and a second portion extending from the first portion and forming a sound tunnel. The sound tunnel has an opening at an end opposite the first portion, and a flexible skirt (e.g., flexible dome or flexible tapered section) projecting over the second portion to resiliently seal with the user's ear canal when inserted therein.

In another embodiment, an ear interface is provided for an ear phone, which physically engages with and acoustically connects to a user's ear. The interface comprises a hollow, flexible body that is adapted to fit in the concha of the user's ear. The body includes a generally oval perimeter that generally corresponds to the perimeter of the concha, and the body further includes a smooth, generally flat oval contact face adapted to overlie the surface of the concha of the user's ear. An elongate crus relief groove extends transversely across it for accommodating the crus of helix of the user's ear.

A first portion of the perimeter of the body is adapted to fit under the tragus and an adjacent second portion of the perimeter of the body is adapted to fit under the antitragus when the body is engaged in the concha. A tube projects from the generally flat oval contact face adjacent one end. The ear interface further comprises a flexible skirt projecting over the second portion to resiliently seal with the user's ear canal when inserted therein.

The tube may project from the contact face at an angle of about 100°. The crus relief groove narrows in width from one side of the contact face to the other. The crus relief groove includes a thinner wall thickness than a remainder of the contact face.

Still another embodiment provides a method of making an ear interface for an ear phone. Generally, the method comprises molding an ear interface body a first portion having a first surface that defines a concave crus relief feature; and a second portion extending from the first portion and forming a sound tunnel having an opening at an end opposite the first portion, and a bowl-shaped formation (or a tapered section formation) extending from the end of the second portion, and thereafter, inverting the bowl-shaped formation (or the tapered section formation) over the second portion to form a dome-shaped element (or the tapered section) projecting over the second portion that can resiliently seal with the users ear canal when inserted therein.

The interface can be conveniently molded in a three piece mold with the first portion being molded between a base member and an intermediate member, the second portion molded in the intermediate member, and the bowl-shaped element being molded between the intermediate member and a top mold member.

An earpiece system, comprising an ear interface adapted to fit with a speaker and to fit in a user's ear is provided. The enhancer includes a first portion including a first surface that defines a concave crus relief feature. The enhancer includes a second portion extending from the first portion and forming a sound tunnel having an opening at an end opposite the first portion, and a flexible tapered section projecting over the second portion to resiliently seal with the user's ear canal when inserted therein.

An ear interface for an ear phone is provided. The ear interface physically engages with and acoustically connects to a user's ear. The interface comprises a hollow, flexible body that is adapted to fit in the concha of the user's ear. The body includes a generally oval perimeter that generally corresponds to the perimeter of the concha. The body further includes a smooth, generally flat oval contact face adapted to overlie the surface of the concha of the user's ear. The contact face including an elongate crus relief groove extending transversely across it for accommodating the crus of helix of the user's ear.

The interface further includes a first portion of the perimeter of the body being adapted to fit under the tragus and an adjacent second portion of the perimeter of the body being adapted to fit under the antitragus when the body is engaged in the concha. The interface further includes a tube projecting from the generally flat oval contact face adjacent one end, and a flexible tapered projecting over the second portion to resiliently seal with the user's ear canal when inserted therein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An earpiece system comprising:
an enhancer configured to receive an earbud of a speaker and to fit in a user's ear, the enhancer including:
a first portion having a first surface that defines a concave crus relief feature;
a second portion extending from the first portion and forming a sound tunnel having an opening at an end opposite the first portion, and
a flexible skirt positioned with the sound tunnel and projecting over the first portion to resiliently seal with the user's ear canal when inserted therein.

2. The earpiece system of claim 1, wherein the first portion further comprises a flat surface at least partially surrounding the second portion, generally perpendicular thereto.

3. The earpiece system of claim 1, wherein the enhancer further includes a traction feature including a crus relief groove oriented generally transversely to the first surface defining the crus relief feature.

4. The earpiece system of claim 3, wherein the traction feature includes first and second groups of notches situated on respective first and second sides of the crus relief feature.

5. The earpiece system of claim 1, wherein the first portion defines an opening for receiving the earbud.

6. The earpiece system of claim 1, wherein the first portion defines a first central axis extending through a center of the first portion and the opening of the second portion defines a second central axis extending through the sound tunnel, and wherein the first central axis is angularly offset from the second central axis.

7. The earpiece system of claim 1, wherein the sound tunnel is formed of a flexible wall having a thickness that is greater than a thickness of the flexible skirt to support the flexible skirt upon insertion into the user's ear canal.

8. The earpiece system of claim 1, wherein the flexible skirt is one of a flexible dome and a flexible tapered section.

9. The earpiece system of claim 1, wherein the flexible skirt surrounds a majority of the sound tunnel.

10. The earpiece system of claim 1 wherein the sound tunnel is configured to flex inward in response to an interior wall of the user's ear canal applying a force against the flexible skirt and the sound tunnel to prevent the user from experiencing discomfort.

11. The earpiece system of claim 1 wherein the flexible skirt projects from the first portion at an angle of about 100°.

12. An earpiece system comprising:
an enhancer configured to engage a speaker and to fit into a user's ear, the enhancer including:
a first portion;
a fraction feature including a plurality of grooves radially oriented on the first portion;
a second portion extending from the first portion and forming a sound tunnel having an opening at an end opposite the first portion; and
a flexible skirt positioned with the sound tunnel and projecting over the first portion to resiliently seal with the users ear canal when inserted therein.

13. The earpiece system of claim 12, wherein the enhancer further includes a concave crus relief feature formed on a first surface of the first portion.

14. The earpiece system of claim 12, wherein the first portion includes an opening for receiving an earbud.

15. The earpiece system of claim 12, wherein the sound tunnel is formed of a flexible wall having a thickness that is greater than a thickness of the flexible skirt to support the flexible skirt upon insertion into the user's ear canal.

16. The earpiece system of claim 12, wherein the flexible skirt is one of a flexible dome and a flexible tapered section.

17. The earpiece system of claim 12, wherein the flexible skirt surrounds a majority of the sound tunnel.

18. The earpiece system of claim 12 wherein the sound tunnel is configured to flex inward in response to an interior wall of the user's ear canal applying a force against the flexible skirt and the sound tunnel to prevent the user from experiencing discomfort.

19. The earpiece system of claim 12 wherein the flexible skirt projects from the first portion at an angle of about 100°.

20. An earphone for connection to an audio source, the earphone comprising:
a speaker; and
an enhancer configured to engage the speaker and to fit into a user's ear, the enhancer including:
a flexible hollow body defining a concave crus relief feature on an outer surface thereof and configured to fit into the user ear;
a tube extending from the outer surface and having an opening at an end opposite the body; and
a flexible tapered section positioned with the tube and projecting over the body to resiliently seal with a user's ear canal when inserted therein.
